(19) United States
(12) Patent Application Publication
(10) Pub. No.: US 2026/0018078 A1
(43) Pub. Date: Jan. 15, 2026

(54) REAL TIME MONITORING OF CANDIDATE IN EXAMINATIONS

(71) Applicant: EXAMROOM.AI CORP., Lake Mary, FL (US)

(72) Inventors: Vinod Kumar JAYAKEERTHI, Sorrento, FL (US); Parshant KUMAR, Bangalore (IN)

(73) Assignee: EXAMROOM.AI CORP., Lake Mary, FL (US)

(21) Appl. No.: 19/266,909

(22) Filed: Jul. 11, 2025

Related U.S. Application Data
(60) Provisional application No. 63/671,388, filed on Jul. 15, 2024.

(51) Int. Cl. G09B 7/00; G06V 10/82; G06V 20/40; G06V 20/52; G06V 40/20

(52) U.S. Cl. CPC G09B 7/00; G06V 10/82; G06V 20/41; G06V 20/52; G06V 40/20

(57) ABSTRACT

Embodiment of the present disclosure relate to method, system and computer program products system of administering an examination at a candidate computing device communicatively coupled with a test administration server within a distributed computing network, by continuously monitoring a candidate performance context during administration of the examination in accordance with an initial level of monitoring parameters, and on detection of an anomaly associated with the candidate performance context, activating an escalated level of monitoring based at least in part upon detecting the anomaly, transmitting, to a proctor computing system, a candidate performance alert based on the anomaly, and receiving, from the proctor computing system based on the candidate performance alert, a proctor intervention assessment.

### RELATED APPLICATIONS

This application claims priority from U.S. Provisional Patent Application No. 63/671,388 filed on Jul. 15, 2024 at the United States Patents and Trademarks Office titled “ESCALATED REAL TIME MONITORING OF CANDIDATE COMPLIANCE IN REMOTE EXAMINATIONS,” the contents of which is hereby incorporated by reference in its entirety.

### TECHNICAL FIELD

Embodiments of the present disclosures herein relate to monitoring candidates in examinations, and more specifically to monitoring candidates in real-time during examinations, especially when examinations are being administered to the candidates at remote locations.

### BACKGROUND

The introduction and increasing prevalence of online examinations and especially such online examinations being conducted remotely for candidates has necessitated a requirement for secure, reliable and efficient technologies that facilitate a seamless experience while maintaining a high level of integrity associated with the examination ecosystems. By providing efficient, reliable and test administering processes fairly, test candidates as well as test and credential certifying entities and institutions can be assured of fairness and consistency in maintaining test standards. Furthermore, enhancing test administering infrastructure and processes in ways that engender confidence in fairness of examination performance results across the population of candidates taking tests and contributes to improving integrity of the examination ecosystem, especially for remotely conducted examinations.

### DESCRIPTION OF THE DRAWINGS

The detailed description is described with reference to the accompanying figures. Features, aspects, and advantages of the subject matter of the present disclosure will be better understood with regard to the following description and the accompanying drawings. The figures are intended to be illustrative, not limiting, and are generally described in context of the embodiments, and it is not intended to limit the scope of the disclosure to these particular embodiments. In the figures, the same numbers may be used throughout the drawings to reference features and components. In order that the present disclosure may be readily understood and put into practical effect, reference will now be made to exemplary embodiments as illustrated with reference to the accompanying figures. The figures together with detailed description below, are incorporated in and form part of the specification, and serve to further illustrate the embodiments and explain various principles and advantages. Novel aspect characteristics of the present disclosure are set forth in the appended claims, embodiments described herein will be understood by those of skill in the art with reference to the following detailed description and accompanying drawing figures in which reference numerals indicate similar or identical features and components.

FIG. 1 is an exemplary illustration of an architecture of a test administering server computer system in a distributed computer network system for escalated monitoring of candidate's compliance in examinations that are administered remotely in accordance with the embodiments of the present disclosure.

FIG. 2 illustrates an example architecture 200 of test administering server 103 of networked system 100 for monitoring of exam candidate compliance in administering tests remotely in accordance with the embodiments of the present disclosure.

FIG. 3 illustrates an exemplary method 300 of monitoring a candidate for compliance while administering tests, or exams as referred to herein, via computer network system 100 in accordance with the embodiments of the present disclosure.

FIG. 4 illustrates another exemplary method 400 of escalated monitoring of the candidate compliance in administering tests remotely over network 100 in accordance with the embodiments of the present disclosure.

FIG. 5 illustrates in a further exemplary method 500 of escalated monitoring of the candidate compliance in administering tests remotely over network 100 in accordance with the embodiments of the present disclosure.

### DETAILED DESCRIPTION

Embodiments presented herein recognize challenges in delivering and administering examinations, including standardized professional tests, that may be dispersed globally across remote locations and countries. Among other advantages and benefits, the methods, techniques, systems and features disclosed herein in the present disclosure enable real-time testing experience for test candidates (also referred to as candidates) that becomes comparable to taking the test at a locally administered test venue, notwithstanding the candidate's remote location status. Other benefits and advantages include maintaining the integrity of test (also referred to hereinafter as examination or assessment, the words may be interchangeably used in the present disclosure but have the same meaning) content presented while ensuring fairness and consistency of the test as administered to such candidates regardless of their location status, where the candidate may be at a remote location. Exemplary embodiments of the present disclosures herein further provide remote testing methods, techniques, systems and features designed to be scalable, flexible, adaptable and compatible with various educational levels, diverse test subject fields and/or educational institutions and/or professional institutions.

Embodiments of the present disclosure related to a system, a computer program product and a method for monitoring a candidate (also referred to as test candidate) while administering an examination (also referred to as test and/or knowledge assessment and/or assessment) to the candidate on a candidate device (also referred to as candidate test device). In an exemplary case, the candidate may be co-located at the examination center and/or remotely located from the examination center. In an exemplary case, a candidate's performance (performance herein in the present disclosure also refers to and broadly encompasses candidate's actions and/or candidate's movements and/or candidate's activities and/or candidate's behavior and/or candidate's acts) is continuously monitored during an examination in accordance with an initial level of monitoring parameters set forth by at least one of the examination administrator and/or a client and/or a third party on behalf of the client and/or any other authorized person who may be authorized to conduct the examination. In an exemplary case, the initial level of monitoring parameters is set forth by an entity, and the entity in the present disclosure refers to at least one of is an examination administrator, a client, a third party acting on behalf of the client, authorized person acting on behalf of the examination administrator, and authorized person acting on behalf of the client. In an exemplary case, responsive to the monitoring of the candidate, detecting any anomaly associated with the candidate's performance with respect to the monitoring parameters that are defined or preset. In an exemplary case, the anomaly may include any deviation with respect to the monitoring parameters set forth by the entity, where entity includes at least one of is an examination administrator, a client, a third party acting on behalf of the client, authorized person acting on behalf of the examination administrator, and authorized person acting on behalf of the client. In an exemplary case, based upon detecting the anomaly associated with any of the monitoring parameters, at least one of activating a proctor and/or intimating a proctor, the proctor associated with the examination being conducted for the candidate. In an exemplary case, based on detection of the anomaly, performing an escalated level of monitoring of the candidate by the proctor during the examination. In an exemplary case, on suspicion of the anomaly and/or detection of the anomaly the examination and the candidate is monitored by the proctor, thereby providing an enhanced level of security for the examination and ensuring fairness in the examination. Advantages and benefits of the remote testing methods, techniques, systems and features disclosed herein enable examination administering entities and institutions to safeguard the integrity of test content presented to candidates, ensure fairness in administering the content across globally/diversely located candidates, as well as ensuring integrity of test performance results as submitted by such candidates,

In an exemplary case, the monitoring parameters (which may also be referred as pre-set rules or examination rules or rules) include and are not limited to at least one of an unauthorized object proximate to the candidate, an unauthorized object proximate to the candidate device, an unauthorized person proximate to the candidate, an unauthorized person proximate to the candidate device, an unauthorized action by the candidate, an unauthorized communication by the candidate, an unauthorized access by the candidate, any unauthorized movement by the candidate, and an unauthorized access by a candidate device. In an exemplary case, the monitoring parameters can be set forth in rules and guidelines that can be implemented and monitored during the course of the examination. In an exemplary case, an unauthorized object proximate to the candidate may include and not be limited to any other electronic, such as a mobile phone, PDA etc., and/or non-electronic device proximate to the candidate, such as a paper, book etc. In an exemplary case, an object proximate to the candidate device may include and not be limited to any other electronic, such as a mobile phone, PDA etc., and/or non-electronic device proximate to the candidate, such as a paper, book etc., especially when there may be a distance between the candidate and the candidate device. In an exemplary case, if the candidate device is a desktop computer with the monitor on the table and the computer device below the table, there may be objects placed close to the computer below the table which may be used by the candidate to copy and/or cheat during the examination. In an exemplary case, any unauthorized movement by the candidate may be tracking the eye movement when the candidate is looking at their hands and/or legs where content may be written and used in answering the examinations. In an exemplary case, the object may also include a person hiding under the table close to the computer, who may help the candidate answer questions during the examination. It should be obvious that several other techniques, systems and methods may be used to cheat during the examination and all such variations fall within the scope of the present disclosure and additionally supervising and checking the monitoring parameters in general establish a secure and safe environment for the candidate to take the examination.

In an exemplary case, monitoring is performed by at least one of an imaging device, an audio device, and a module to detect movement of the candidate during the examination, and may not be limited to these devices and models, and it should be obvious to a person of ordinary skill in the art that with improvement in technology many other devices may be used to monitor the candidate, such as sensors etc., and all such devices that may be used for monitoring candidates in an examination fall within the scope of the embodiments of the present disclosure. In an exemplary case, the module may be a software module and/or a hardware module and/or a combination thereof. In an exemplary case, generally a software module may be pushed onto the candidate device prior to taking the examination and activated on the candidate's device to check if there are any anomalies occurring with respect to the candidate, especially in remotely administered tests, during the course of the examination. In an alternative case, when the candidate's device is co-located, a hardware module may be activated on the candidate's device (device used to take the examination) to check if there are any anomalies occurring with respect to the candidate during the course of the examination.

In an exemplary case, the imaging device may be coupled to the candidate device or may be externally attached to the candidate device. In an exemplary case the imaging device may capture a continuous video stream during the examination. In an exemplary case, the imaging device may perform image capture at pre-defined intervals of time during the examination, when the video stream is continuously streaming. In an exemplary case, the imaging device may additionally capture a series of images at random time and/or capture a series of images at pre-defined time intervals, where the pre-defined time intervals may be set by the entity. In an exemplary case, the imaging device may additionally capture panoramic images pre-defined time and/or panoramic images random time intervals, where the pre-defined time intervals may be set by the entity. In an exemplary case, the audio device may capture any sound and/or any audio proximate to the candidate and/or the candidate device. In an exemplary case, the module, which may be a software that additionally runs on the computer during the examination, may be configured to monitor the monitoring parameters and may be for in one case the continuous movement of the candidate during the examination, and may additionally capture a series of images in real-time and/or at pre-defined time intervals as decided by at least one of the entity.

In an exemplary case, on detection of the anomaly with respect to the monitoring parameters, the imaging device may be configured for capturing a series of images automatically at any time during the examination, wherein the images may be used as evidence and/or in any administrative proceedings with respect to the candidate. In an exemplary case, on detection of the anomaly with respect to the monitoring parameters, the imaging device may be configured for capturing a continuous video stream during the examination, or on activation by the proctor, wherein the videos may be used as evidence and/or in any administrative proceedings with respect to the candidate. In an exemplary case, on detection of the anomaly with respect to the monitoring parameters, the audio device may be configured for recording sound and/or any audio proximate to the candidate and the candidate device during the examination, wherein the sound and/or audio may be used as evidence and/or in any administrative proceedings with respect to the candidate.

In an exemplary case, the module may be an object detection module or any other model that is associated with computer vision and may be advantageously implemented in accordance with the embodiments of the present disclosure, and the module may be associated with the detection of an object and the module may incorporate at least one of a neural network, convolutional neural networks (CNN), deep-CNN, Region-Based Convolutional Neural Networks (R-CNN), Fast R-CNN, and YOLO (You Only Look Once). It should be obvious to a person of ordinary skill in the art that other techniques and/or algorithms may be employed to and all such models and/or techniques and/or algorithms fall within the scope of the embodiments of the present disclosure. In an exemplary case, the module may include localizing the objects and/or classifying the objects that may be observed in the images and/or in the series of images and/or in the panoramic images and/or in parts of a video stream that may be recorded during the examination.

In an exemplary case, the image capture by the imaging device (which may also be referred to as image capture device) or the imaging device being guided by the module includes at least a time lapse image capture, wherein the time lapse image capture may include a change and/or a movement occurring over a pre-defined time interval during the examination to detect any anomaly, and the pre-defined time interval being defined by at least one of the examination administrator, the client, and the authorized third party on behalf of the client. In an exemplary case, a correlation coefficient may be determined for each of the monitoring parameters, and the correlation coefficient defines minimal threshold value associated with each of the monitoring parameters. In an exemplary case, the correlation coefficient defined a numerical measure that describes the strength and direction of a relationship and typically ranges from −1 to +1. In an exemplary case, +1 indicates a positive correlation, wherein when one variable increases the other increases, −1 indicates a negative correlation, wherein when one variable increases the other variable decreases, and 0 indicates no linear correlation. In an exemplary case the closer the coefficient is to +1 or −1 the stronger is the relationship between the variables and a coefficient closer to 0 indicates a weak or no linear relationship. In an exemplary case, it should be obvious to a person of ordinary skill in the art that there are different types of correlation coefficients, with Pearson's product-moment correlation coefficient being the most common for linear relationships, and other types include Spearman's rank correlation coefficient for monotonic relationships (where the variables tend to move in the same direction, but not necessarily linearly), Cramer's V correlation which identical to Pearsons coefficient, Concordance Correlation Coefficient, Intraclass Correlation, Kendall's Tau, Moran's I, Partial Correlation, Phi Coefficient, Point Biserial Correlation, Zero-Order Correlation and all such variations of correlation coefficient may be used for the embodiments of the present disclosure and all such variations fall under the scope of the embodiments of the present disclosure. In an exemplary case, determining the correlation coefficient assists the examination administrator or the proctor in assessing how changes in one variable can predict changes in another variable, and a high correlation does not necessarily imply causation.

In an exemplary case, Pearson correlation coefficient (r) may be computed using the formula, if x and y are two variables

$$r = \sum [ ( {x}_{i} - \overline{x} ) ( {y}_{i} - \overline{y} ) ] / √ [ \sum {( {x}_{i} - \overline{x} )}^{2} \sum {( {y}_{i} - \overline{y} )}^{2} ] ,$$

where xᵢ and yᵢ are the data points, and x̅ and y̅ are the means of the respective variables under consideration. If the correlation coefficient value is positive, then there is a similar and identical relation between the two variables, else the indication is that there is dissimilarity between the two variables. It should be obvious to a person of ordinary skill in the art that correlation coefficient values typically range from −1 to 1, where a correlation coefficient value close to 1 shows a very positive string relationship for the two variables and a correlation coefficient value close to −1 indicates a negatively strong relationship for two variables. It should be obvious to a person of ordinary skill in the art that similarly other correlation coefficients may be computed based on the algorithm used and all such algorithms and correlations fall within the scope of the present disclosure.

An exemplary case may include retaining, as potential evidence in case of any administrative proceeding in any forms of disputes that may arise post the examination, and the potential evidence may include time stamped information associated with the at least one of the videos, images and audios associated with respect to the monitoring parameters of the candidate performance alert, the proctor intervention assessment, a test candidate identification number, a test candidate authentication profile, and a test identification number. In an exemplary case, the administrative proceedings may include an arbitration that has at least the test candidate and the examination administering entity and further includes at least one of updating and modifying a candidate profile in accordance with an outcome of the arbitration. In an exemplary case, the examination administering entity may include at least one examination administrator and/or a client and/or a third party on behalf of a client and/or any other authorized person who may be authorized to conduct the examination.

Embodiments of the present disclosure provide a system and method of administering an examination at a candidate on a computing device (also referred to as a candidate device or a candidate computing device) that may be remotely located from at least one of a proctor computing system (hereinafter also referred to as a proctor device) and a test administering server (TAS). Additionally, the candidate device, the proctor device and the TAS may be co-located, i.e. be at the same geographical location but still be at different locations within the same co-located space. In an exemplary case, the candidate device, the proctor device and the TAS may be all within a distributed computing network coupled by wired means, wireless means and/or a combination thereof. In an embodiment, the system and method include continuously monitoring candidate's performance during administration of the plurality of items, for each of the items administered to the candidate in accordance with an initial level of monitoring parameters, wherein the monitoring parameters may vary for each of the candidates or a group of candidates, The candidates performance is defined by the entity, the entity is at least one of is an examination administrator, a client, a third party acting on behalf of the client, authorized person acting on behalf of the examination administrator, and authorized person acting on behalf of the client,

In an exemplary case, detecting, responsive to the continuous monitoring, any kind of anomaly associated with the candidate performance with respect to the monitoring parameters, and then activating an escalated level of monitoring based at least in part upon detecting the anomaly. In an exemplary case, embodiments include transmitting to a proctor device, the candidate performance alert based on the initial and escalated levels, and receiving, from the proctor device based on the candidate performance alert, a proctor intervention of the candidate and assessment of the candidate via the proctor. In an exemplary case, retaining, as potential evidence in an administrative proceeding, time stamped information associated with the initial and escalated levels of monitoring, the candidate performance alert, the proctor intervention assessment, a test candidate identification number, a test candidate authentication profile, and a test identification number. In an exemplary case, the method and system also include updating and/or modifying a candidate performance profile in accordance with an outcome of the administrative proceeding.

In another exemplary case, the monitoring includes activating at least a escalated level of monitoring upon detecting any anomaly in candidate performance that is associated with the deviation of the monitoring parameters. Also provided is a TAS computing system that includes one or more processors and memory storing instructions executable in the one or more processors. In an exemplary case, the instructions, when executed in the one or more processors, cause the one or more processors to implement operations including continuously monitoring a candidate performance during performance of the examination in accordance with the monitoring parameters defined by the entity, detecting, responsive to the continuously monitoring, any anomaly associated with the candidate performance, activating an escalated level of monitoring based at least in part upon detecting the anomaly. In an exemplary case, transmitting, to a proctor device, a candidate performance alert based on the deviation with respect, and receiving, from the proctor computing system based on the candidate performance alert, a proctor to the monitoring parameters intervention assessment of the candidate by the proctor. In an exemplary case, is provided a computer-readable non-transitory memory having processor executable instructions stored thereon. In an exemplary case, the instructions, when executed in one or more processors, causing the one or more processors to implement operations including as described previously of monitoring the candidates' performance and brining in intervention of assessment by a proctor.

Reference is now made to FIG. 1, which illustrates an example embodiment of a networked system 100 for escalated monitoring of exam candidate compliance in administering tests remotely in accordance with the embodiments of the present disclosure. In accordance with the embodiments of the present disclosure, networked system 100 includes test administering server 103 (TAS) having a monitoring logic module 105, configured for monitoring parameters set forth by the entity, where the entity is at least one of is an examination administrator, a client, a third party acting on behalf of the client, authorized person acting on behalf of the examination administrator, and authorized person acting on behalf of the client. One or more logic modules as described herein may be instantiated via execution of the processor, executable instructions stored in a processor, readable memory device. It is contemplated that the executable instructions constituting one or more logic modules 105 may be stored in portions or an entirely across networked system 100, such as and not limiting to computing devices 101, 102, 103 as depicted in FIG. 1. Candidate device (also referred to herein as candidate computing device) 102, is communicatively coupled to TAS 103 and proctor device 101, via network 104, which may be and not limited to Local Area Network (LAN), Wide Area Network (WAN), Metropolitan Area Network (MAN), Wireless LANs (WLAN), Cloud based networks (CBN). Campus Area Network (CAN), Passive Optical LAN (POLAN), Enterprise private network (EPN), Virtual Private Network (VPN), System Area Network (SAN) and Personal Area Network (PAN), which may be categorized by the size and geographical scope. In another embodiment, the external hardware device may be used to interface with the candidate device and the test may be administered to the candidate on the candidate device using the external hardware device, for example a USB. Network systems and computing devices coupled to each other via the networked system provides a platform for conducting an examination for assessment of a candidate, which may also include a group of candidates, and specifically an exam performance platform for a given candidate or group of candidates taking the exam, and the candidate submit responses to items, the test items or exam items, presented for assessment of the candidate. As referenced herein, the network may include any one of the above-mentioned network systems and/or a combination thereof.

Monitoring logic module 105 (hereinafter referred to as logic modules or logic modules for monitoring or monitoring modules) may be on candidate device 102 and includes processor executable instructions that configure candidate device 102, and candidate device 102 is specifically for the purposes of administering exams to candidate. Such configuration, in some cases, is instantiated during the course of the exam under performance by the exam candidate. In an example configuration, upon detecting any anomaly related to candidate with respect to any of the monitoring parameters (herein after also referred to as the exam compliance rules) set by the entity, the entity is at least one of is an examination administrator, a client, a third party acting on behalf of the client, authorized person acting on behalf of the examination administrator, and authorized person acting on behalf of the client, in the proctor device 101 or TAS 103, the processor executable instructions of monitoring logic module 105 may be configured to cause one or more monitoring devices installed on candidate device 102 to become enabled, or activated, monitoring logic module 105 and intimate the proctor device 101 and/or TAS 103. Monitoring is performed by monitoring device (not shown in the Figure) and includes at least one of and is not limited to an imaging device, an audio device, and a module to detect movement of the candidate during the examination for detection of the anomaly.

The monitoring parameters may include at least one of and not be limited to an unauthorized object proximate to the candidate, an unauthorized object proximate to the candidate device, an unauthorized person proximate to the candidate, an unauthorized person proximate to the candidate device, an unauthorized action by the candidate, an unauthorized communication by the candidate, an unauthorized access by the candidate, any unauthorized movement by the candidate, and an unauthorized access by a candidate device. The monitoring device may be configured to provide images and/or audio and/or any movement detected during the course of the examination which may be acquired to proctor device 101 and/or TAS 103. Such monitoring devices may be installed on candidate device 102 or may be external devices communicatively coupled to candidate device 102. Exemplary monitoring devices may include and not be limited to an imaging device, such as a camera or video imaging device, an audio device, a hardware and/or software module activating at least one of the audio and/or imaging device to detect movement related to the candidate performance (physical context of the candidate) and/or surroundings (proximate area around the candidate and the candidate device) to at least one of proctor device 101 and/or TAS 103. As used herein, the term anomaly includes, but are not limited to, activities may be sensed and/or observed that are contrary to the monitoring parameters and/or compliance with exam rules by the candidate. Such activities include, but are not limited to, an unauthorized object, an unauthorized person, an unauthorized communication action by the test candidate or an unauthorized accessing, by the candidate device, of information and human contacts via the networked system 100.

TAS 103 is communicatively coupled to, or may incorporate, database item bank 103a (database hereinafter also referenced to as a repository). In this manner, networked system 100 for administering tests remotely is deployed using processor devices and memory in interconnected test delivery and administering servers working conjunctively, as will be apparent to those of skill in the art of distributed computer networking systems and cloud computing systems. In an exemplary case, repository may be structured data and/or unstructured data and/or a combination thereof. In an exemplary case, the test essentially includes a test package that is administered to a candidate who may be remotely located, and the test being administered by the entity. where the entity includes and is not limited to at least one of is an examination administrator, a client, a third party acting on behalf of the client, authorized person acting on behalf of the examination administrator, and authorized person acting on behalf of the client.

Monitoring logic module 105, which includes monitoring logic, includes processor executable instructions that enable proctor device 101 to monitor candidate device 102 for candidate compliance purposes in the exam being administered to the candidate. Proctor device 101 enables monitoring devices such as imaging devices, audio devices or other sensor devices installed on candidate device 102 and/or coupled to candidate device 102, and may be activated on detection of an suspicious activity and/or activated by proctor device 101 and/or activated by TAS 103, for providing data related to monitoring of candidates with respect to the monitoring parameters related to the candidate performance (physical context) and/or surroundings of the candidate and/or the candidate device to proctor device 101 and/or TAS 103.

In some aspects, such activation is triggered upon detecting, by the monitoring devices that is external to candidate device 102 but may be placed in the physical surroundings or context of the exam candidate remote location, at least some evidence based on observing an anomaly in the immediate physical environment, or observed physical actions, of the candidate performing the examination at the candidate device 102, where the anomaly is with respect to the monitoring parameters and/or exam rules defined by the entity. The anomaly as disclosed previously may be and not limited to an unauthorized object, an unauthorized person, an attempted but unauthorized communication action by the candidate, unauthorized access by the candidate device of information and human contacts etc., via the networked system 100. Monitoring logic module 105 of proctor device 101 includes logic for communicatively controlling the monitoring device, which includes a video surveillance camera or other imaging device that is installed in the physical surroundings of candidate device 102, enabling acquisition of at least some evidence of any anomaly based on continuously monitoring the examination candidate and their immediate surroundings prior to, or during, the examination. In some variations, acquiring the evidence of an anomaly may be enabled and controlled by escalated monitoring logic module 105 of TAS 103, as an alternative, or in addition to, monitoring logic module 105 of proctor device 101. It should be obvious to a person of ordinary skill in the art that the entire monitoring logic module may include several different components for candidate monitoring, proctor assisted monitoring and monitoring by the TAS, and each of these may function differently but work in unison to ensure that the exam is conducted and monitored without any issues and in a smooth manner.

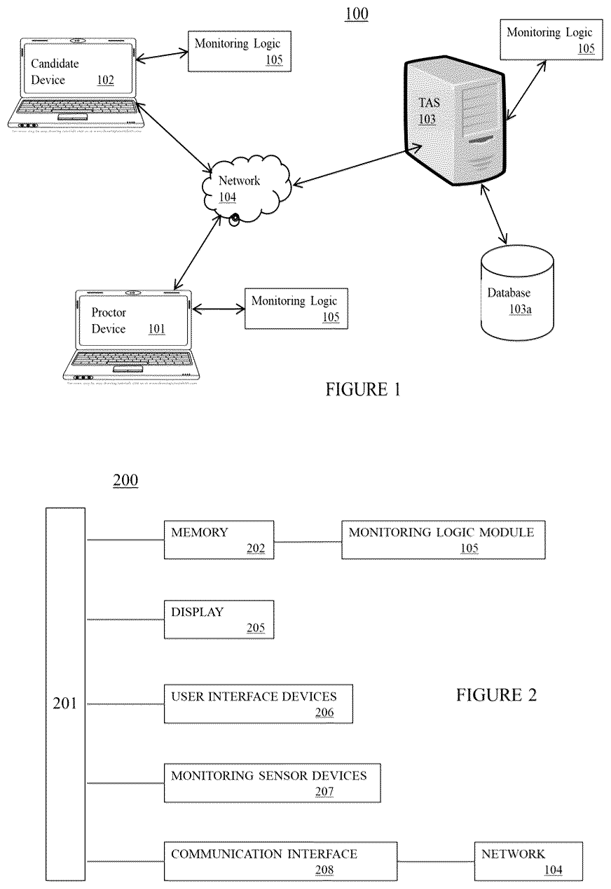

Reference is now made to FIG. 2, which illustrates an example architecture 200 of test administering server 103 of networked system 100 for monitoring of exam candidate compliance in administering tests remotely in accordance with the embodiments of the present disclosure. Architecture 200 is described herein with reference to TAS 103. However, it is contemplated that, as will be appreciated by a person of ordinary skill in the art, that at least some portions of logic componentry and functionality ascribed to TAS 103 may be incorporated into any number of server computing devices, or other computing devices, deployed within proctor device 101, and/or similar interconnected computing systems, in alternate or additional embodiments of the present disclosure. For instance, it may be contemplated that at least some of the functionality of TAS 103 can be implemented and/or incorporated variously, including in portions or an entirety, across other types of server computing systems interconnected therewith via network 104.

Monitoring logic module 105, which includes monitoring logic, which may be implemented using programmable instructions stored in memory 202 that are executable in one or more processor devices, including such as and not limited to processor 201. Memory 202 may include, though not necessarily be limited to, non-volatile memory device(s), including dynamic random access memory (DRAM) or static random access memory (SRAM) non-transitory memory storage media or devices, and/or any combinations thereof. Although functionality ascribed to monitoring logic module 105 is described herein, for sake of providing clarity to a person of ordinary skill in the art, in context of a single discrete logic module, it is expected that functionality ascribed to monitoring logic module 105 herein should not be limited in implementation to such literal configuration and may be constituted of a plurality of functionally equivalent logic modules. In some variations, at least some portions of functionality of monitoring logic module 106 may be implemented in accordance with hard-wired circuitry and/or electronic componentry. The hard-wired circuitry and/or electronic componentry may be, without limitation, such as field programmable gate array (FPGA) devices, application specific integrated circuit (ASIC) devices and similar hard-wired electronic circuitry and/or componentry device implementations.

In an exemplary case, monitoring logic module 105 includes processor-executable instructions stored in memory 202, which, when executed in processor 201, cause processor 201 to implement operations for escalated real time monitoring of candidate compliance with rules and/or monitoring parameters and/or mandates that are established by the entity to ensure integrity of remotely administered examinations or even for examination that may be administered at co-located spaces, where the candidate, TAS and proctor are different locations within a co-located space.

Monitoring logic module 105 includes processor-executable instructions stored in memory 202, which, when executed in processor 201, cause processor 201 to implement operations for continuously monitoring a candidate performance during course of the examination being administered on candidate device which may be remotely located or co-located in accordance with an initial level monitoring with respect to the monitoring parameters as disclosed above.

Monitoring logic module 105 further includes processor-executable instructions for detecting, responsive to continuously monitoring the candidate device for any anomaly associated with the candidate performance. The anomaly may be indications associated with the candidate performance that evidences an attempt to contravene the monitoring parameters as discussed above which may define the examination rules or examination mandate to be managed during administration of the examination on the candidate device. For instance, an initial level of monitoring may indicate an unauthorized object, an unauthorized person, an unauthorized communication action by the candidate and/or the candidate device accessing an unauthorized resource, such as a third party computing resources via the network.

Monitoring logic module 105 also includes processor-executable instructions for activating an escalated level of continuous monitoring based at least in part upon detecting the anomaly. Where activating the escalated level of monitoring includes activating at least one or more monitoring device that is different from the monitoring device deployed in accordance with the initial level monitoring, where the initial level of monitoring may be related to video stream. In some exemplary cases, the candidate device includes a monitoring device such as an image capture device, and activating an escalated level of monitoring includes accessing and activating the image capture device of that candidate device, wherein the escalated level of monitoring may include capturing frames of images and enabling object detection with the images captured. In some exemplary variation, the escalated level of monitoring may involve more than just video or image monitoring, for instance, the escalated level of monitoring may include monitoring communications in accordance with input and output communication channels and/or ports of the candidate device to ascertain instances where proscribed communications with extrinsic sources or third parties may have been attempted and/or conducted by the candidate, in contravention of the monitoring parameters set forth. In an exemplary case, results of the escalated level of monitoring may include annotations evidencing such attempts by the candidate.

In some exemplary variation, the initial and escalated levels, or escalated levels as the case may be, are monitored by separate and different third-party monitoring service providers. Each monitoring service provider may have an associated quality of level service and/or capability. Such a scaling system enables sequential escalations to be performed by more capable service providers, commensurate with degree of seriousness of candidate deviations with regard to compliance with the set of monitoring parameters, which define the exam rules. Advantageously, such use of independent and separate service providers also assures provide assurance to the candidate that they will be less likely to be subjected to undue bias that might be associated with, or inherent to, any one given monitoring service provider.

Monitoring logic module 105 includes processor-executable instructions for transmitting, to a proctor device coupled to the network, a candidate performance alert based on the monitoring at an initial level of monitoring, which may be more relaxed and an escalated level, which may be a more stringent level of monitoring. In some exemplary cases, the candidate performance alert may include a report that includes still and/or video images, sound and/or other audio acquired in accordance with both an initial level of monitoring and escalated level of monitoring in conjunction with respective annotations regarding candidate performance. In some exemplary cases, the instructions are further directed to retaining, as potential evidence in an administrative proceeding, time stamped information associated with the monitoring of the candidate, preferably with the initial and escalated levels of monitoring, the candidate performance alert, the proctor intervention assessment, a test candidate identification number, a test candidate authentication profile, and a test identification number. The administrative proceeding can be an arbitration between, or attended by, at least the candidate and an entity that administers the examination, based upon which outcome the candidate performance profile can be modified or updated to reflect the outcome of the arbitration, and/or the final assessment of the candidate.

Monitoring logic module 105 includes processor-executable instructions for receiving, from the proctor device based on the candidate performance alert, a proctor intervention assessment. Based on the candidate performance alert transmitted to the proctor device 101, a proctor may survey the totality of results from the monitoring, for example the initial and escalated levels of monitoring, add further observations and/or attestations on candidate performance and behavior as observed during the examination, and verify whether, or confirm that, monitoring systems appear to be functioning as intended.

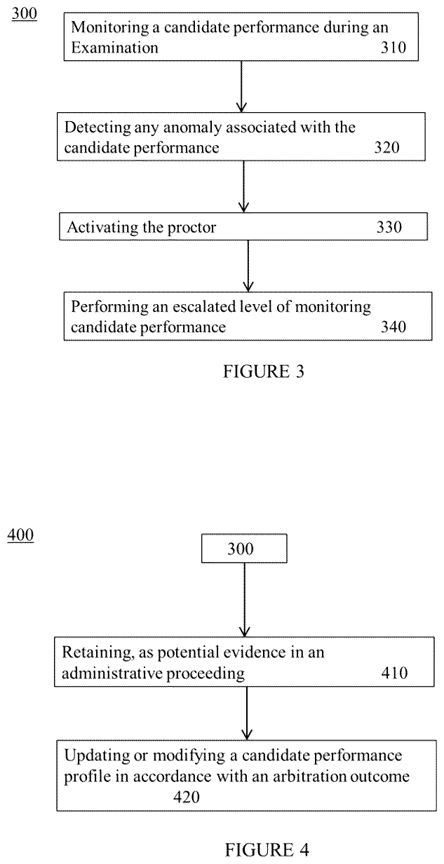

Reference is now made to FIG. 3, which illustrates an exemplary method 300 of monitoring a candidate for compliance while administering tests, or exams as referred to herein, via computer network system 100. In accordance with the embodiments of the present disclosure method 300 may be implemented by applying any of the devices, systems, techniques and features as described in FIGS. 1-2. In accordance with the embodiments of the present disclosure, method 300 may be implemented via computer processor executable instructions stored on memory storage media devices. In accordance with other embodiments of the present disclosure, at least some of the computer processor executable instructions stored on memory storage media devices may be implemented, wholly or at least partially, in electronically hardwired devices, including, without limitation, field programmable gate array (FPGA) semiconductor devices or application specific integrated circuit (ASIC) semiconductor devices.

The method for monitoring a candidate for compliance with respect to the monitoring parameters while administering test to the candidate on the candidate device may be fully implemented in a single instance or may be divided into an initial level of monitoring which includes a relaxed type of monitoring and an escalated level of monitoring on detection of anomaly with respect to the monitoring parameters, where the escalated level of monitoring will be in a more stringent form, whether monitored by a machine/device or has any human interventions such as a proctor being involved. At step 310, the method include continuously monitoring, in the course of an examination performed at the candidate device, the candidate performance with respect to the monitoring parameters set forth by the entity, wherein the monitoring parameters may be provided in a single set of rules (which has been referenced to as parameters) or may include an initial set of rules and a escalated set of rules. The candidate device is communicatively coupled within a network to a proctor device and a TAS, and the candidate performance in accordance with respect to the set of monitoring parameters is monitored.

At step 320, detecting, responsive to the continuous monitoring of the candidate at the candidate device and/or location, any anomaly associated with the candidate performance, with respect to the monitoring parameters defined or classified as initial set of monitoring parameters and escalated set of monitoring parameters. It should be obvious that several other combination and/or variations may be created from the set of monitoring parameters and all such variations fall within the scope of the present disclosure. In some exemplary instances, the anomaly may be indications that the candidate is attempting to contravene the examination rules and/or examination mandates, defined by the monitoring parameters, wherein the monitoring parameters may vary from examination to examination. For instance, a continuous video monitoring may indicate the presence of an unauthorized object, an unauthorized person, an unauthorized communication action by the candidate and/or an unauthorized accessing, by the candidate device, of third party computing resources via the network.

At step 330, based on the detection of any anomaly with respect to the monitoring parameters set forth by the entity for the examination, transmitting, to proctor device and/or the TAS, the candidate performance alert based on the monitoring of the parameters and activating a proctor and the TAS, and simultaneously recording the anomaly for purpose of evidence in case of an arbitration or any other proceedings, which may be initiated by the candidate or the entity. In a specific exemplary case, when the initial set of parameters and the escalated set of parameters are defined, the candidate performance alert based on the initial level is recorded and sent for proctors' intervention for monitoring the candidate at escalated level during the course of the examination.

The anomaly may be indications associated with the candidate's performance that evidences an attempt to contravene examination rules or the examination mandates that have been set forth by the entity. For instance, continuous monitoring and/or an initial level of continuous video may indicate an unauthorized object, an unauthorized person, an unauthorized communication action by the candidate and/or an unauthorized accessing, by the candidate device, of third party computing resources via the distributed computing network.

In an exemplary, either automatically/dynamically or manually activating the proper intervention for further monitoring, or automatically/dynamically or manually the escalated level of monitoring which includes activating at least one other monitoring device that is different from the initially activated monitoring device. In some exemplary cases, the candidate device includes an image capture device, and activating the escalated level of monitoring may include accessing and activating the image capture device with enhanced capabilities such as object detection etc. In some exemplary variations, the monitoring may involve more than just video and/or image monitoring, for instance, monitoring communications in accordance with input and output communication channels and/or ports of the candidate device to ascertain instances where proscribed communications with extrinsic sources or third parties may have been attempted or conducted by the examination candidate, in contravention of examination rules. In an exemplary case, result of the monitoring or escalated level of monitoring may include annotations evidencing such attempts by the examination candidate.

In some exemplary variations, the initial and escalated level, or escalated levels as the case may be, may be monitored by separate and different third-party monitoring service providers. Each monitoring service provider may have an associated quality of level service and/or capability. Such a scaling system enables sequential escalations to be performed by more capable service providers, commensurate with degree of seriousness of candidate deviations with regard to compliance with respect to the monitoring parameters which will define the exam rules for the examination. Advantageously, such use of independent and separate service providers also assures provide assurance to the examination candidate that they will be less likely to be subjected to undue bias that might be associated with, or inherent to, any one given monitoring service provider.

Monitoring logic module 105 includes processor-executable instructions for transmitting, to a proctor device, a candidate performance alert based on the monitoring parameters with respect to the candidate and/or the examination set forth by the entity. Based on the candidate performance alert transmitted to the proctor device, a proctor may survey the totality of results from the monitoring, (initial level and/or escalated level) add further observations and/or attestations on candidate performance and behavior as observed during the examination, and verify whether, or confirm that, monitoring systems appear to be functioning as intended. In an exemplary case, the candidate performance alert may include a report that includes still images and/or video streams/clips and/or sound/audio records acquired in accordance with the monitoring (initial level and escalated level) in conjunction with respective annotations regarding candidate performance. In some exemplary cases, the instructions are further directed to retaining, as potential evidence in an administrative proceeding, time stamped information associated with the initial and escalated levels of monitoring, the candidate performance alert, the proctor intervention assessment, a test candidate identification number, a test candidate authentication profile, and a test identification number. The administrative proceeding can be an arbitration between, or attended by, at least the candidate and an entity that administers the examination, based upon which outcome the candidate performance profile can be modified or updated to reflect the outcome of the arbitration, and a final assessment of the candidate may be made.

Reference is now made to FIG. 4, which illustrates another exemplary method 400 of escalated monitoring of the candidate compliance in administering tests remotely over network 100. Method 400 may be performed, in some embodiments, in conjunction with techniques of method 300 as described herein. At step 410, the method includes retaining, as potential evidence in an administrative proceeding, time stamped information associated with the initial and escalated levels of monitoring, the candidate performance alert, the proctor intervention assessment, a test candidate identification number, a test candidate authentication profile, and a test identification number. At step 420, the method further includes updating and/or modifying a candidate performance profile in accordance with an outcome of the arbitration. The steps have been previously described in the present disclosure.

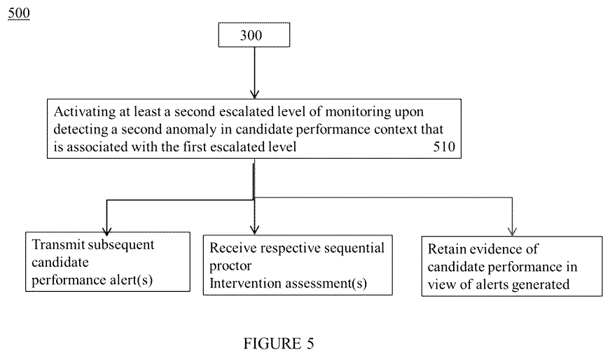

Reference is now made to FIG. 5, which illustrates, in a further exemplary method 500 of escalated monitoring of the candidate compliance in administering tests remotely over network 100. Method 500 may be performed, in some embodiments, in conjunction with method 300 as described herein. At step 510, the method includes activating at least a second escalated level of monitoring upon detecting a second anomaly in candidate performance context that is associated with the first escalated level. The candidate performance alert transmitted to a proctor device, in example, includes results of the escalated monitoring. In cases where additional, sequential escalations are warranted or conducted, it is contemplated that cumulative results of the escalated monitoring can be captured and rendered in the alerts and retained as evidence in cases where results of the monitoring are contested.

It is contemplated that embodiments described herein be understood to include and encompass varying combinations of elements and concepts recited anywhere in this application. Although embodiments are described in detail herein with reference to the accompanying drawings, it is to be understood that the invention is not limited to only such literal embodiments. For example, it is anticipated that the techniques and systems may be applied or deployed to administering of examinations other than remote examination configurations. Furthermore, it is contemplated that a particular feature described either individually or as part of an embodiment can be combined with other features as described, or parts of other embodiments, even in the absence of a particular described combination. Thus, the absence of particular described combinations does not preclude the inventor from claiming rights to such combinations. As such, many modifications and variations will be apparent to practitioners skilled in the art. Accordingly, it is intended that the scope of the invention be defined by the following claims and their equivalents.

Although the present disclosure has been described with reference to several preferred embodiments, it should be understood that the present disclosure is not limited to the preferred embodiments disclosed here. Embodiments of the present disclosure are intended to cover various modifications and equivalent arrangements within the spirit and scope of the appended claims. Although the foregoing disclosure has been described in some detail for purposes of clarity of understanding, it will be apparent that certain changes and modifications may be practiced within the scope of the appended claims. Examples of the present disclosure have been described in language specific to structural features and/or methods. It should be noted that there are many alternative ways of implementing both the process and apparatus of the present invention. Accordingly, embodiments of the present disclosure are to be considered illustrative and not restrictive, and the invention is not to be limited to the details given herein but may be modified within the scope and equivalents of the appended claims. It should be understood that the claims appended are not necessarily limited to the specific features or methods described. Rather, the specific features and methods are disclosed and explained as examples of the present disclosure.

What is claimed is:

1. A method of monitoring a candidate while administering an examination to the candidate on a candidate device, the method comprising:
continuously monitoring a candidate's performance during administration of an examination in accordance with an initial level of monitoring parameters, wherein the initial level of monitoring parameters is set forth by an entity, wherein the entity is at least one of is an examination administrator, a client, a third party acting on behalf of the client, authorized person acting on behalf of the examination administrator, and authorized person acting on behalf of the client;
detecting, responsive to the monitoring, any anomaly associated with the candidate's performance, wherein the anomaly comprises a deviation with respect to the monitoring parameters;
based upon detecting the anomaly associated with the monitoring parameters, at least one of activating a proctor or intimating a proctor; and
performing an escalated level of monitoring of the candidate's performance by the proctor during the examination.

2. The method of claim 1, wherein the monitoring parameters comprise at least one of an unauthorized object proximate to the candidate, an unauthorized object proximate to the candidate device, an unauthorized person proximate to the candidate, an unauthorized person proximate to the candidate device, an unauthorized action by the candidate, an unauthorized communication by the candidate, an unauthorized access by the candidate, any unauthorized movement by the candidate, and an unauthorized access by a candidate device.

3. The method of claim 1, wherein monitoring is performed by at least one of an imaging device, an audio device, and a module to detect movement of the candidate during the examination for detection of the anomaly.

4. The method of claim 3, wherein the imaging device is configured to perform during the examination at least one or more of capture a continuous video stream, capture images at pre-defined intervals of time, capture a series of images at random time, capture a panoramic image pre-defined time, capture a panoramic image random time interval.

5. The method of claim 3, wherein the audio device is configured capture any at least one of an audio or sound proximate to the candidate and the candidate device.

6. The method of claim 3, wherein the module is activated during the examination and active during the examination, wherein the module is configured to monitor a movement with respect to the candidate, and on detection of the movement, the module configured for capturing at least one of a series of images or record a video stream.

7. The method of claim 6, wherein the module comprises an object detection model, wherein the object detection module comprising at least one of a neural network, convolutional neural networks (CNN), deep-CNN, Region-Based Convolutional Neural Networks (R-CNN), Fast R-CNN, and YOLO (You Only Look Once).

8. The method of claim 7, wherein the module is configured to localize and classify any objects within the images, the series of images, the panoramic images, and the video stream.

9. The method of claim 4, wherein the image capture includes at least a time lapse image capture, wherein the time lapse image capture comprises a change or a movement occurring over a pre-defined time interval during the examination detecting the anomaly, and the pre-defined time interval being defined by at least one of the examination administrator, the client, the authorized third party on behalf of the client, and the authorized person acting on behalf of the examination administrator.

10. The method of claim 1, wherein a correlation coefficient is determined for each of the monitoring parameters, wherein the correlation coefficient defines a minimal threshold value associated with each of the monitoring parameters, and if the correlation coefficient is determined to be above the minimal threshold value, reporting to at least one of the examination administrator, the client, the authorized third party on behalf of the client, and the authorized person acting on behalf of the examination administrator the anomaly with respect to the monitoring parameters.

11. The method of claim 1, further comprises retaining, as potential evidence in an administrative proceeding, a time stamped information associated with the monitoring parameters of the candidate performance alert, a proctor intervention assessment, a candidate identification number, a candidate authentication profile, and a test identification number, wherein the monitoring parameters is associated with at least one of the videos, the images and the audios documented during the examination.

12. The method of claim 11, wherein the administrative proceedings comprise an arbitration including at least the candidate and the entity and further comprises: at least one of updating and modifying a candidate profile in accordance with an outcome of the arbitration.

13. A test administering server computing system comprising: one or more processors; a memory storing instructions executable in the one or more processors, the instructions, when executed in the one or more processors, causing the one or more processors to implement operations comprising:
continuously monitoring a candidate's performance during administration of an examination in accordance with an initial level of monitoring parameters, wherein the initial level of monitoring parameters is set forth by an entity, wherein the entity is at least one of is an examination administrator, a client, a third party acting on behalf of the client, authorized person acting on behalf of the examination administrator, and authorized person acting on behalf of the client;
detecting, responsive to the monitoring, any anomaly associated with the candidate's performance, wherein the anomaly comprises a deviation with respect to the monitoring parameters;
based upon detecting the anomaly associated with the monitoring parameters, at least one of activating a proctor or intimating a proctor; and
performing an escalated level of monitoring of the candidate's performance by the proctor during the examination.

14. The system of claim 13, wherein the monitoring parameters comprises at least one of an unauthorized object proximate to the candidate, an unauthorized object proximate to the candidate device, an unauthorized person proximate to the candidate, an unauthorized person proximate to the candidate device, an unauthorized action by the candidate, an unauthorized communication by the candidate, an unauthorized access by the candidate, any unauthorized movement by the candidate, and an unauthorized access by a candidate device.

15. The system of claim 14, wherein monitoring is performed by at least one of an imaging device, an audio device, and a module to detect movement of the candidate during the examination for detection of the anomaly.

16. The system of claim 15, wherein the imaging device is configured to perform during the examination at least one or more of capture a continuous video stream, capture images at pre-defined intervals of time, capture a series of images at random time, capture a panoramic image pre-defined time, capture a panoramic image random time interval.

17. The system of claim 15, wherein the audio device is configured capture any at least one of an audio or sound proximate to the candidate and the candidate device.

18. The system of claim 15, wherein the module is activated during the examination and active during the examination, wherein the module is configured to monitor a movement with respect to the candidate, and on detection of the movement, the module configured for capturing at least one of a series of images or record a video stream.

19. The method of claim 18, wherein the module comprises an object detection model, wherein the object detection module comprising at least one of a neural network, convolutional neural networks (CNN), deep-CNN, Region-Based Convolutional Neural Networks (R-CNN), Fast R-CNN, and YOLO (You Only Look Once), and wherein the module is configured to localize and classify any objects within the images, the series of images, the panoramic images, and the video stream.

20. The system of claim 16, wherein the image capture includes at least a time lapse image capture, wherein the time lapse image capture comprises a change or a movement occurring over a pre-defined time interval during the examination detecting the anomaly, and the pre-defined time interval being defined by at least one of the examination administrator, the client, the authorized third party on behalf of the client, and the authorized person acting on behalf of the examination administrator.

21. The system of claim 13, wherein a correlation coefficient is determined for each of the monitoring parameters, wherein the correlation coefficient defines a minimal threshold value associated with each of the monitoring parameters, and if the correlation coefficient is determined to be above the minimal threshold value, reporting to at least one of the examination administrator, the client, the authorized third party on behalf of the client, and the authorized person acting on behalf of the examination administrator the anomaly with respect to the monitoring parameters.

22. The system of claim 13, further comprises retaining, as potential evidence in an administrative proceeding, a time stamped information associated with the monitoring parameters of the candidate performance alert, a proctor intervention assessment, a test candidate identification number, a test candidate authentication profile, and a test identification number, wherein the monitoring parameters is associated with at least one of the videos, the images and the audios documented during the examination.

23. The system of claim 22, wherein the administrative proceedings comprises an arbitration including at least the candidate and the entity and further comprises: at least one of updating and modifying a candidate profile in accordance with an outcome of the arbitration.

24. A computer-readable non-transitory memory having instructions stored thereon, the instructions when executed in one or more processors causing the one or more processors to implement operations comprising:
continuously monitoring a candidate's performance during administration of an examination in accordance with an initial level of monitoring parameters, wherein the initial level of monitoring parameters is set forth by an entity, wherein the entity is at least one of is an examination administrator, a client, a third party acting on behalf of the client, authorized person acting on behalf of the examination administrator, and authorized person acting on behalf of the client;
detecting, responsive to the monitoring, any anomaly associated with the candidate's performance, wherein the anomaly comprises a deviation with respect to the monitoring parameters;
based upon detecting the anomaly associated with the monitoring parameters, at least one of activating a proctor or intimating a proctor; and
performing an escalated level of monitoring of the candidate's performance by the proctor during the examination.
